(19) United States
(12) Patent Application Publication
(10) Pub. No.: US 2024/0331174 A1
(43) Pub. Date: Oct. 3, 2024

(54) One Shot PIFu Enrollment

(71) Applicant: Apple Inc., Cupertino, CA (US)

(72) Inventors: Ran Luo, San Jose, CA (US); Olivier Soares, Oakland, CA (US); Rishabh Battulwar, Santa Clara, CA (US)

(21) Appl. No.: 18/615,217

(22) Filed: Mar. 25, 2024

Related U.S. Application Data
(60) Provisional application No. 63/493,580, filed on Mar. 31, 2023.

(51) Int. Cl. G06T 7/50; G06T 7/73; G06T 13/40; G06T 17/20

(52) U.S. Cl. CPC G06T 7/50; G06T 7/73; G06T 13/40; G06T 17/20; G06T 2207/30196

(57) ABSTRACT

Generating a 3D representation of a subject includes obtaining an image of a physical subject. Front depth data is obtained for a front portion of the physical subject. Back depth data is obtained for the physical subject based on the image and the front depth data. A set of joint locations is determined for the physical subject from the image, the front depth data, and the back depth data.

### BACKGROUND

Computerized characters that represent users are commonly referred to as avatars. Avatars may take a wide variety of forms including virtual humans, animals, and plant life. Existing systems for avatar generation tend to inaccurately represent the user, require high-performance general and graphics processors, and generally do not work well on power-constrained mobile devices, such as smartphones or computing tablets.

### BRIEF DESCRIPTION OF THE DRAWINGS

FIG. 1 shows a flow diagram for generating a 3D occupation field and joint locations, according to some embodiments.

FIG. 2 shows a flowchart of a technique for determining a 3D occupation field and joint locations for a subject depicted in a single image, according to one or more embodiments.

FIG. 3 shows a diagram of a technique for determining joint locations using a feature network in accordance with some embodiments.

FIG. 4 shows a flowchart of a technique for predicting joint locations based on derived back data, in accordance with some embodiments.

FIG. 5 depicts an example flow diagram of a technique for determining a skeleton of a subject based on predicted joint locations, in accordance with one or more embodiments.

FIG. 6 shows flowchart of a technique for driving an avatar based on the predicted joint locations, according to some embodiments.

FIG. 7 shows, in block diagram form, a simplified system diagram according to one or more embodiments.

FIG. 8 shows, in block diagram form, a computer system in accordance with one or more embodiments.

### DETAILED DESCRIPTION

This disclosure relates generally to techniques for enhanced enrollment for avatar generation. More particularly, but not by way of limitation, this disclosure relates to techniques and systems for determining a reconstruction mesh of a subject and joint locations based on a single image.

This disclosure pertains to systems, methods, and computer readable media to determine a 3D shape of a subject as well as predict joint locations for the subject based a single image. According to some embodiments, an input image is applied to a feature network, such as an image encoder, to obtain surface features for the subject. By sampling a given feature point of the image, a feature vector can be obtained. Then, given the feature vector, and a given depth value, a classification network can predict whether the given point (e.g., the x, y coordinates of the sampled feature point, plus the given z coordinate) is inside or outside the volume of the subject. By doing so for all 3D points, the surface of the volume can be recovered, for example using a marching cube algorithm.

In some embodiments, the process additionally involves determining, based on the front depth and back depth of the 3D shape, a set of joints for the subject. In some embodiments, the front and back depths can be determined from the 3D shape. For example, for a given pixel, a depth indicative of the front surface and the back surface can be identified. In some embodiments, the front depth may be obtained from depth sensor data captured by a device, or from depth data associated with the image. In some embodiments, the back depth can be determined using a network that considers the features from the image and/or the front depth data to predict back depth data. Using the image, the front depth data, and the back depth data, a joint network can predict the locations of a set of joints for the subject.

In the following description, for purposes of explanation, numerous specific details are set forth in order to provide a thorough understanding of the disclosed concepts. As part of this description, some of this disclosure's drawings represent structures and devices in block diagram form in order to avoid obscuring the novel aspects of the disclosed embodiments. In this context, it should be understood that references to numbered drawing elements without associated identifiers (e.g., 100) refer to all instances of the drawing element with identifiers (e.g., 100a and 100b). Further, as part of this description, some of this disclosure's drawings may be provided in the form of a flow diagram. The boxes in any particular flow diagram may be presented in a particular order. However, it should be understood that the particular flow of any flow diagram is used only to exemplify one embodiment. In other embodiments, any of the various components depicted in the flow diagram may be deleted, or the components may be performed in a different order, or even concurrently. In addition, other embodiments may include additional steps not depicted as part of the flow diagram. The language used in this disclosure has been principally selected for readability and instructional purposes and may not have been selected to delineate or circumscribe the disclosed subject matter. Reference in this disclosure to “one embodiment” or to “an embodiment” means that a particular feature, structure, or characteristic described in connection with the embodiment is included in at least one embodiment, and multiple references to “one embodiment” or to “an embodiment” should not be understood to refer necessarily to the same embodiment or to different embodiments.

It should be appreciated that in the development of any actual implementation (as in any development project), numerous decisions must be made to achieve the developers' specific goals (e.g., compliance with system and business-related constraints) and that these goals will vary from one implementation to another. It should also be appreciated that such development efforts might be complex and time-consuming but would nevertheless be a routine undertaking for those of ordinary skill in the art of image capture having the benefit of this disclosure.

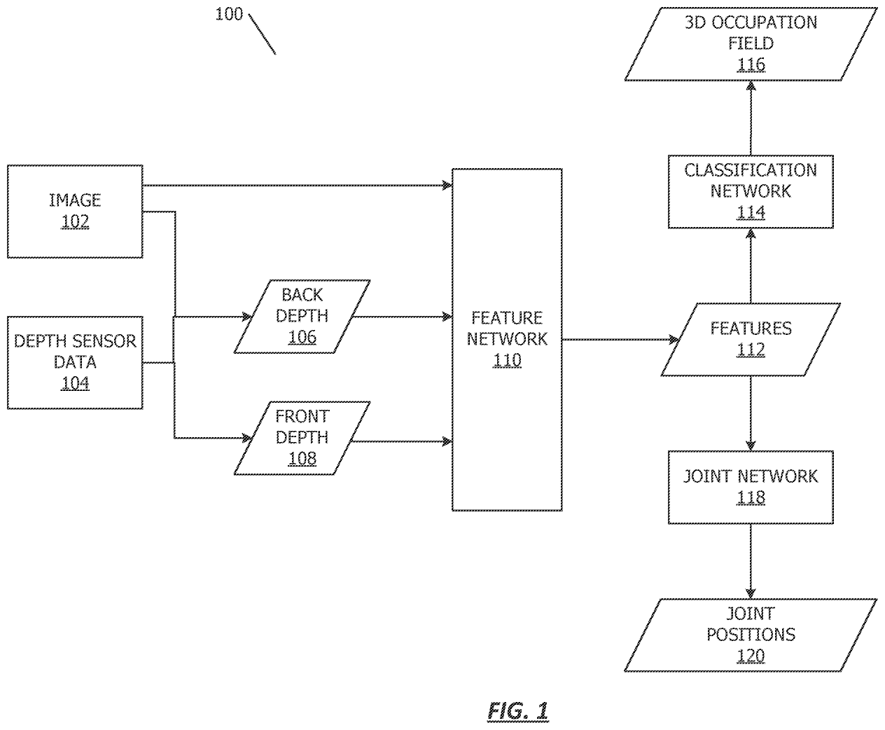

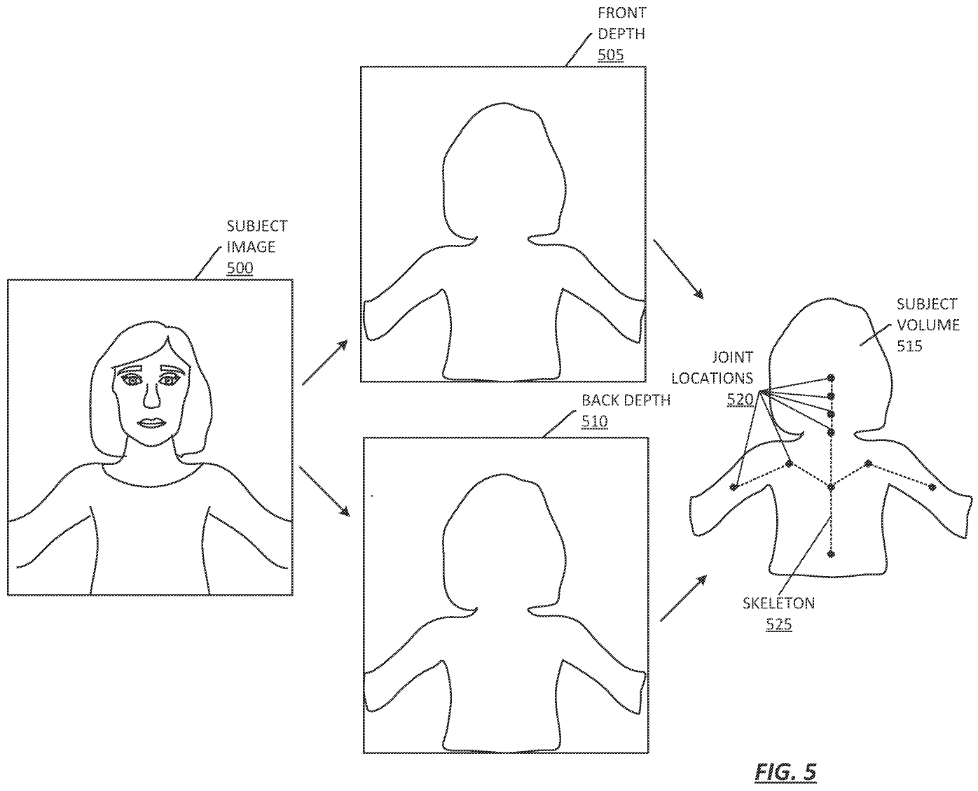

Turning to FIG. 1, a flow diagram is shown for generating a 3D occupation field and determining joint information based on a single input image, according to some embodiments. For purposes of explanation, the following steps will be described in the context of the components presented in FIG. 1, and looking forward with respect to the example flow diagram depicted in FIG. 5. However, it should be understood that the various actions may be performed by alternate components. In addition, the various actions may be performed in a different order. Further, some actions may be performed simultaneously, and some may not be required, or others may be added.

The flow diagram 100 begins with an input image 102. The input image 102 may be an image of a user or other subject, such as the subject image 500 shown in FIG. 5. In some embodiments, the image 102 may be captured, for example, during an enrollment period in which a user utilizes a personal device to capture an image directed at the user's face from which enrollment data may be derived for rendering avatar data associated with the user.

In addition to the image 102, depth sensor data 104 may be obtained corresponding to the image. That is, depth sensor data 104 may be captured by one or more depth sensors which correspond to the subject in the image 102. Additionally, or alternatively, the image 102 may be captured by a depth camera and the depth and image data may be concurrently captured. As such, the depth sensor data 104 may indicate a relative depth of the surface of the subject from the point of view of the device capturing the image/sensor data. For example, turning to FIG. 5, the depth sensor data 104 may include, or be used to determine, front depth 505.

According to one or more embodiments, the image 102 may be applied to a feature network 110 to obtain a set of features 112 for the image 102. The feature network 110 may additionally use back depth data 106 and front depth data 108. In one or more embodiments, the feature network 110 is configured to provide a feature vector for a given pixel in an image. A given sampled 3D point in space will have X, Y, and Z coordinates. From the X, Y coordinates, a feature vector is selected from among the features 112 of the images.

In some embodiments each of the feature vectors are combined with the corresponding Z coordinate for the given sampled 3D point, to obtain feature vector 112 for the sampled 3D point at each image. According to one or more embodiments, the feature vector 112 may be applied to a classification network 114 to determine a classification value for the particular sampled 3D point for each input vector. For example, returning to the example image 102, for a given sampled 3D point, a classification value may be determined. In some embodiments, the classification network may be trained to predict a relation of a sampled point to the surface of the subject presented in the input image 102. For example, in some embodiments, the classification network 114 may return a value between 0-1, where 0.5 is considered to be on a surface, and 1 and 0 are considered to be inside and outside, respectively, the 3D volume of the subject delineated by the surface. Accordingly, for each sampled 3D point across the input images, a classification value is determined. A 3D occupation field 116 for the user can be derived from a combination of the classification values from the classification network 114. For example, the set of classification values may be analyzed to recover a surface of the 3D subject presented in the input image. In some embodiments, this 3D occupation field 116 may then be used for generating representations of the user, or part of the user, such as avatar representations of the user.

In addition to the 3D occupation field, joint locations for the user can be determined from the features 112. The joint network 118 may use the image data 102 as well as the depth information. The depth may include front depth data 108 and back depth data, either from back depth 106, or based on a back depth determined for the 3D occupation field 116 by the classification network 114. The back depth data pay be a back surface of the user from the point of view of the camera, as shown by back depth 510 of FIG. 5. The joint network may be trained to predict joint positions 120 for the user in the image for which the 3D occupation field 116 is predicted.

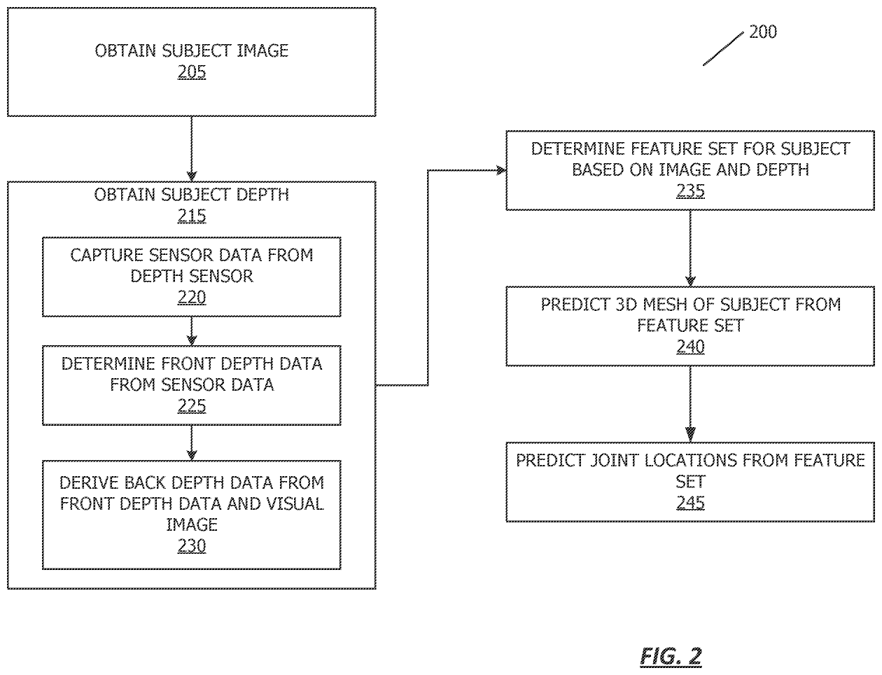

FIG. 2 shows a flowchart of a technique for determining a 3D occupation field and joint locations for a subject depicted in an input image, according to one or more embodiments. For purposes of explanation, the following steps will be described in the context of FIG. 1. However, it should be understood that the various actions may be performed by alternate components. In addition, the various actions may be performed in a different order. Further, some actions may be performed simultaneously, and some may not be required, or others may be added.

The flowchart 200 begins at block 205 where an image of a subject is obtained. The input image may include a visual image of the subject. The image data may be obtained by a single camera or camera system, such as a stereo camera, or other set of synchronized cameras configured to capture image data of a scene in a synchronized manner. According to some embodiments, the image may be a 2D image, or may have 3D characteristics, for example if the image is captured by a depth camera.

The flowchart 200 continues to block 215, where depth information for the subject is obtained. The depth information includes front depth data and back depth data for the subject as depicted in the input image from block 205. In some embodiments, the front depth data may be determined from the subject image, for example if the image is captured by a depth camera or is otherwise provided. Alternatively, the front depth data may be captured from alternative sources. As shown at block 220 sensor data may be captured from a separate depth sensor on the device. At block 225, front depth data may be determined from the depth sensor data. For example, the sensor data captured by the depth sensor may be used to determine depth information for the surface of the user facing the sensor. In some embodiments, a combination of the image data and the depth sensor data may be used. For example, in some embodiments, the depth sensor may have a smaller field of view than the camera capturing the image. As such, the depth data from the depth sensor may be enhanced by considering the image data, for example using a trained network, to determine depth information for portions of the image for which depth sensor data is unavailable, and/or to improve the depth sensor data.

According to one or more embodiments, while the sensor data may not directly capture depth information for a back surface of the user (i.e., the surface of the user facing away from the sensors), at block 230, the back depth data can be derived from the front depth data. This may occur, for example, by using a network that considers the image and/or the front depth data to predict back depth data. According to one or more embodiments, the front depth data indicates, for a given pixel, a point in space at which a device-facing surface of the user is located. Similarly, the back depth data indicates, for a given pixel, at point in space at which the surface of the user facing away from the device is located.

The flowchart 200 continues at block 235, where a feature set is determined based on the image data, front depth data, and back depth data. The feature set may include, for example, a feature vector for each sample point of the image obtained at block 205. The sample point may refer to a 3D point corresponding to a region in which the subject is to be represented. The feature set may be obtained by applying the input image to a feature network, such as an image encoder, to obtain surface features for the subject. By sampling a given feature point of the image, a feature vector can be obtained.

At block 240, a 3D mesh of the subject is predicted from the feature set. The 3D mesh may be determined based on an occupation field corresponding to the subject. In some embodiments, the feature set may be used to determine a classifier value for each sample point. In some embodiments, the classifier value may indicate a predicted relative position of the 3D sample point to the surface of the subject. In some embodiments, pixel-aligned implicit functions (“PIFu”) may be used to obtain the classifier value for each sample point, from each image. As such, the classifier may be trained to predict a classifier value based on a feature vector, which may include a feature vector from a pixel associated with the X, Y coordinate of a given sample point, as well as a z value indicative of depth of the space in which the volume of the subject is to be represented. Thus, from the combination of classifications of the sample points, a 3D occupation field for the subject can be determined.

The flowchart concludes at bock 245, where joint locations are predicted from the feature set. In some embodiments, the feature set is derived from the front depth data, back depth data, and image data. As such, the front depth data and back depth data may be used to constrain the predicted joint locations. In some embodiments, the joint locations may be predicted by a joint network trained to predict joint locations based on the feature set and/or the depth information. In some embodiments, because the determined front depth and derived back depth have already been considered in predicting the feature set, the network may or may not use the front depth data and/or the back depth data as separate inputs to the joint network.

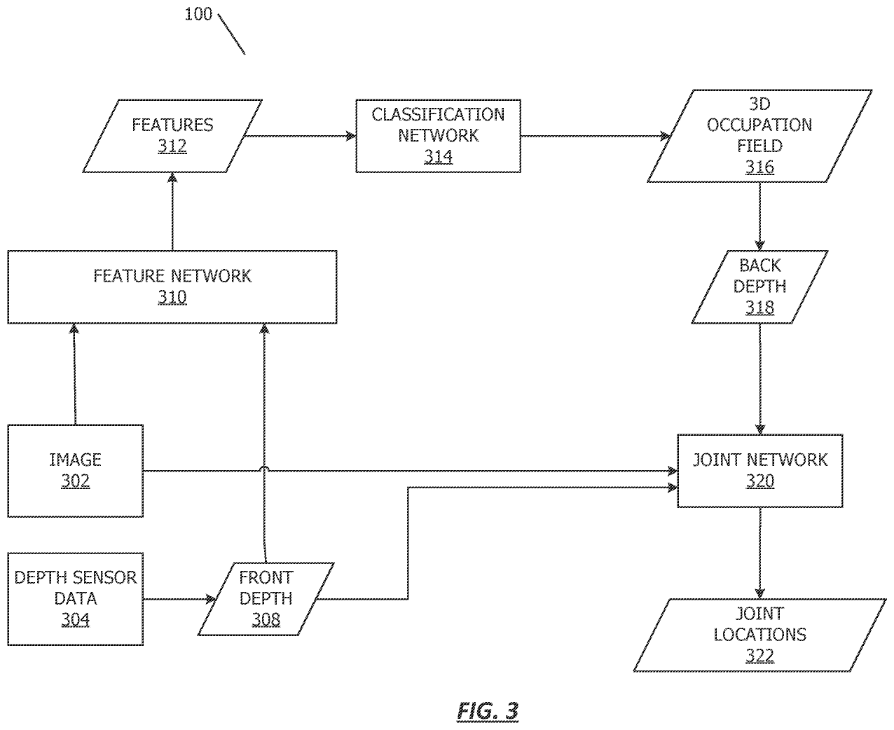

FIG. 3 shows an alternative flow diagram for generating a 3D occupation field and determining joint information based on a single input image, according to some embodiments. In particular, FIG. 3 depicts one or more embodiments in which back depth data is determined from a 3D occupation field predicted from an input image. For purposes of explanation, the following steps are presented in a particular order. However, it should be understood that the various actions may be performed in a different order. Further, some actions may be performed simultaneously, and some may not be required, or others may be added.

The flow diagram 300 begins with an input images 302. The input image 302 may be an image of a user or other subject. In some embodiments, the image 302 may be captured, for example, during an enrollment period in which a user utilizes a personal device to capture an image directed at the user's face from which enrollment data may be derived for rendering avatar data associated with the user.

In addition to the image 302, depth sensor data 304 may be obtained corresponding to the image. That is, depth sensor data 304 may be captured by one or more depth sensors which correspond to the subject in the image 302. Additionally, or alternatively, the image 302 may be captured by a depth camera and the depth and image data may be concurrently captured. As such, the depth sensor data 304 may indicate a relative depth of the surface of the subject from the point of view of the device capturing the image/sensor data.

According to one or more embodiments, the image 302 may be applied to a feature network 310 to obtain a set of features 312 for the image 302. The feature network 310 may additionally use the front depth data 308. In one or more embodiments, the feature network 310 is configured to provide a feature vector for a given pixel in an image. A given sampled 3D point in space will have X, Y, and Z coordinates. From the X, Y coordinates, a feature vector is selected from among the features 312 of the images.

In some embodiments each of the feature vectors are combined with the corresponding Z coordinate for the given sampled 3D point, to obtain feature vector 312 for the sampled 3D point at each image. According to one or more embodiments, the feature vector 312 may be applied to a classification network 314 to determine a classification value for the particular sampled 3D point for each input vector. For example, returning to the example image 302, for a given sampled 3D point, a classification value may be determined. In some embodiments, the classification network may be trained to predict a relation of a sampled point to the surface of the subject presented in the input image 302. For example, in some embodiments, the classification network 314 may return a value between 0-1, where 0.5 is considered to be on a surface, and 1 and 0 are considered to be inside and outside, respectively, the 3D volume of the subject delineated by the surface. Accordingly, for each sampled 3D point across the input images, a classification value is determined. A 3D occupation field 316 for the user can be derived from a combination of the classification values from the classification network 314. For example, the set of classification values may be analyzed to recover a surface of the 3D subject presented in the input image. In some embodiments, this 3D occupation field 316 may then be used for generating representations of the user, or part of the user, such as avatar representations of the user.

Because the 3D occupation field 316 predicts a volume of a user, back depth data 318 can be determined from the 3D occupation field. In particular, the 3D occupation field includes a prediction as to which 3D points are located with respect to a surface of the volume of the subject. As such, the depth of these sample points predicted to be on the back surface of the user may be used as the back depth data 318.

A joint network 320 can be trained to predict joint locations 322 based on an input image, as well as front depth data and back depth data. The joint locations may indicate, for each of a set of predefined joints for a subject, a location in 3D space. By using the front and back depths along with the image data, the depth of the joints can be constrained in 3D space.

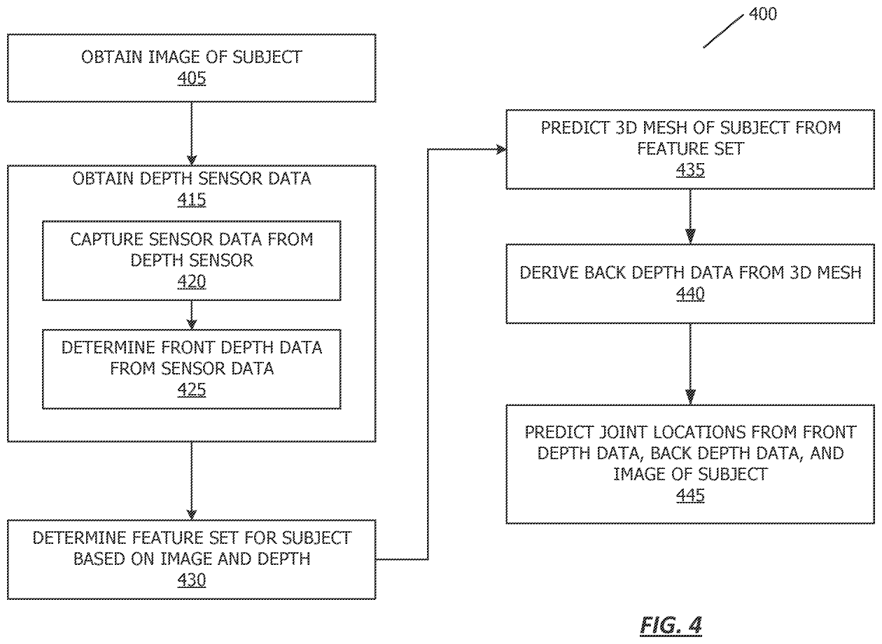

FIG. 4 shows a flowchart of a technique for determining a 3D occupation field and joint locations for a subject depicted in an input image, according to one or more embodiments. For purposes of explanation, the following steps will be described in the context of FIG. 3. However, it should be understood that the various actions may be performed by alternate components. In addition, the various actions may be performed in a different order. Further, some actions may be performed simultaneously, and some may not be required, or others may be added.

The flowchart 400 begins at block 405 where an image of a subject is obtained. The input image 405 may include a visual image of the subject. The image data may be obtained by a single camera or camera system, such as a stereo camera, or other set of synchronized cameras configured to capture image data of a scene in a synchronized manner. According to some embodiments, the image may be a 2D image, or may have 3D characteristics, for example if the image is captured by a depth camera.

The flowchart 400 continues to block 415, where depth information for the subject is obtained. The depth information includes front depth data and back depth data for the subject as depicted in the input image from block 405. In some embodiments, the front depth data may be determined from the subject image, for example if the image is captured by a depth camera or is otherwise provided. Alternatively, the front depth data may be captured from alternative sources. As shown at block 420, sensor data may be captured from a separate depth sensor on the device. At block 425, front depth data may be determined from the depth sensor data. For example, the sensor data captured by the depth sensor may be used to determine depth information for the surface of the user facing the sensor. In some embodiments, a combination of the image data and the depth sensor data may be used. For example, in some embodiments, the depth sensor may have a smaller field of view than the camera capturing the image. As such, the depth data from the depth sensor may be enhanced by considering the image data, for example using a trained network, to determine depth information for portions of the image for which depth sensor data is unavailable, and/or to improve the depth sensor data.

The flowchart 400 continues at block 430, where a feature set is determined based on the image data and front depth data. The feature set may include, for example, a feature vector for each sample point of the image obtained at block 405. The sample point may refer to a 3D point corresponding to a region in which the subject is to be represented. The feature set may be obtained by applying the input image to a feature network, such as an image encoder, to obtain surface features for the subject. By sampling a given feature point of the image, a feature vector can be obtained.

At block 435, a 3D mesh is predicted of the subject based on the feature set. The 3D mesh may be determined based on an occupation field corresponding to the subject. In some embodiments, the feature set may be used to determine a classifier value for each sample point. In some embodiments, the classifier value may indicate a predicted relative position of the 3D sample point to the surface of the subject. In some embodiments, PIFu may be used to obtain the classifier value for each sample points, from each image. As such, the classifier may be trained to predict a classifier value based on a feature vector, which may include a feature vector from a pixel associated with the x, y coordinate of a given sample point, as well as a z value indicative of depth of the space in which the volume of the subject is to be represented. Thus, from the combination of classifications of the sample points, a 3D occupation field for the subject can be determined.

The flowchart 400 continues at block 440, where back depth data is derived from the 3D mesh. In some embodiments, the back depth data may be determined based on the classification values from which the 3D mesh is determined. That is, the location of the surface of the user facing away from the camera can be determined based on the geometry of the 3D mesh.

The flowchart 400 concludes at block 445, where a joint network is trained to predict a set of joint locations based on an input image, as well as front depth data and back depth data. As described above, the front depth data may be determined directly from the sensor data, or derived from the sensor data, while the back depth data can be derived from the mesh and/or classification values. The joint network may then make a prediction for the locations of joints for the user based on the image data, front depth data, and back depth data.

FIG. 5 shows a diagram of a technique for predicting a set of joint locations in accordance with some embodiments. Specifically, FIG. 5 shows an image of a subject 500 for which a set of joint locations is predicted. A subject image 500 may be captured by a camera of an electronic device. The subject image 500 is an image captured by one or more cameras of an electronic device of a user. The subject image 500 may be captured, for example, during a registration process in which a user generates personal data to be used for generating and driving an avatar. The subject image 500 may include image data and/or depth data. In some embodiments, the device capturing the subject image 500 may additionally capture depth information of the subject, for example using a depth sensor.

As described above, the techniques described herein include generating front depth data 505 and back depth data 510 corresponding to the subject image 500. The front depth data 505 may be depth data captured by the depth sensor, or may be depth data determined based on the depth sensor data and the image data. For example, the subject image 500 and depth data captured by the depth sensor coincident with the image 500 may be used as input into a trained network to obtain a predicted front depth 505.

The back depth data 510 may also be derived from the subject image 500. In some embodiments, the back depth data is determined from a network trained to predict back depth information from a given subject image and front depth. Alternatively, in some embodiments, the back depth data may be derived from a 3D occupation volume of the subject, determined, for example, using PIFu techniques. That is, the subject image 500 and the front depth 505 may be used as input into a feature network, from which sample points in a 3D space can be classified with respect to their relationship to the surface of the subject. As a result, a bounding volume of the user can be identified, for example, in the form of a 3D mesh. The back depth 510 may be derived from the sample points determined to be on the surface of the subject facing away from the camera.

According to one or more embodiments, the front depth 505, the back depth 510, and the subject image 500 can be used to determine a set of joint locations 520 for the subject. In particular, a joint network may be trained to predict the locations of a set of joints based on the image data and the depth data, such that the depth data constrains the location of the joints to within the volume 515 of the user.

In some embodiments, the joint network may be configured to determine the location of joints, but may not provide rotational information or other data needed to determine a skeleton of the user. That is, the locations of the individual joints may be determined, but the relationship between the joints may not be generated by the joint network in some embodiments. Rather, an inverse kinematics function can be applied to the joint locations 520 to determine the skeleton 525 for the subject. From here, the skeleton 525 may be used to drive an avatar representation of the subject.

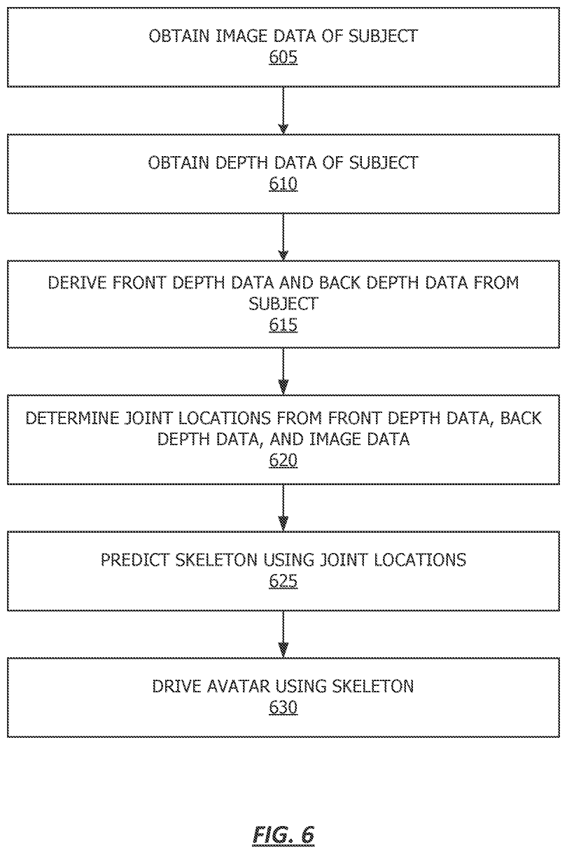

Turning to FIG. 6, a flow diagram is presented depicting a technique for driving an avatar using the predicted joint locations, in accordance with one or more embodiments. For purposes of explanation, the following steps will be described in the context of FIG. 1. However, it should be understood that the various actions may be performed by alternate components. In addition, the various actions may be performed in a different order. Further, some actions may be performed simultaneously, and some may not be required, or others may be added.

The flowchart begins at block 605, where image data of the subject is obtained. In some embodiments, the image data may be captured, for example, during an enrollment period in which a user utilizes a personal device to capture an image directed at the user's face from which enrollment data may be derived for rendering avatar data associate with the user.

The flowchart continues to block 610, where depth sensor data 104 may be obtained corresponding to the image. That is, depth sensor data 104 may be captured by one or more depth sensors captured coincident with the image data of block 605. The depth sensor data 104 may indicate a relative depth of the surface of the subject from the point of view of the device capturing the image/sensor data.

At block 615, front depth data and back depth data are derived from the image data and/or the obtained depth data. As described above, the front depth data may be depth data captured by the depth sensor, or may be depth data determined based on the depth sensor data and the image data. The back depth data may be determined from a network trained to predict back depth information from a given subject image and front depth. Alternatively, in some embodiments, the back depth data may be derived from a 3D occupation volume of the subject, determined, for example, using PIFu techniques.

The flowchart continues to block 620 where joint locations for the subject are determined from the front depth data, back depth data, and image data. The joint locations may be predicted from the front depth data, back depth data, and image data. The joint network may be trained to predict the locations of a set of joints based on the image data and the depth data, such that the depth data constrains the location of the joints to within the volume 515 of the user.

At block 625, a skeleton is predicted using the joint locations. The skeleton may be predicted using the predicted joint locations and inverse kinematics to determine a relative location and connections among the joints which make up the skeleton of the subject. As such, the skeleton includes the joint locations, along with connective information and orientation information from which a pose of the skeleton is determined.

The flowchart concludes at block 630 where an avatar is driven using the skeleton. According to one or more embodiments, a device may capture tracking information of a user and generate a virtual representation of the user performing the tracked movements in the form of an avatar representation. The avatar representation may be based, in part, on the 3D mesh derived from the occupation volume of the subject. In addition, the tracked movements of the subject may be represented by movements of the avatar, which can be generated using the skeleton.

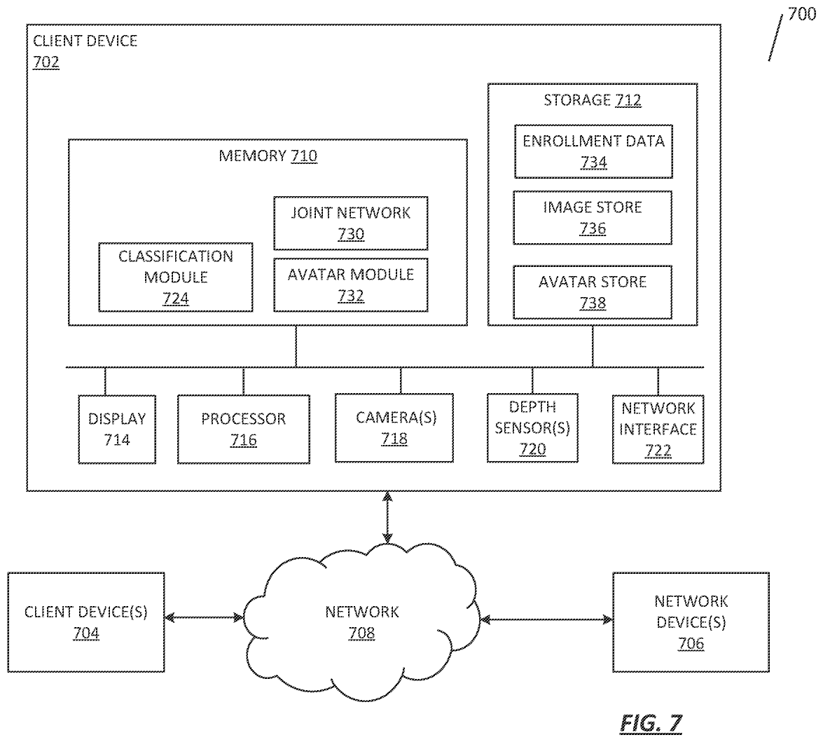

Referring to FIG. 7, a simplified network diagram 700 including a client device 702 is presented. The client device may be utilized to generate a three-dimensional representation of a subject in an environment. The network diagram 700 includes client device 702 which may include various components. Client device 702 may be part of a multifunctional device, such as a phone, tablet computer, personal digital assistant, portable music/video player, wearable device, head mounted device, base station, laptop computer, desktop computer, mobile device, network device, or any other electronic device that has the ability to capture image data.

Client device 702 may include one or more processors 716, such as a central processing unit (CPU). Processor(s) 716 may include a system-on-chip such as those found in mobile devices and include one or more dedicated graphics processing units (GPUs) or other graphics hardware. Further, processor(s) 716 may include multiple processors of the same or different type. Client device 702 may also include a memory 710. Memory 710 may include one or more different types of memory, which may be used for performing device functions in conjunction with processor(s) 716. Memory 710 may store various programming modules for execution by processor(s) 716, including classification module 724, joint network 730, avatar module 732, and potentially other various applications.

Client device 702 may also include storage 712. Storage 712 may include enrollment data 734, which may include data regarding user-specific profile information, user-specific preferences, and the like. Enrollment data 734 may additionally include data used to generate avatars specific to the user, such as a 3D mesh representation of the user, join locations for the user, a skeleton for the user, and the like. Storage 712 may also include an image store 736. Image store 736 may be used to store a series of images from which enrollment data can be determined, such as the input images described above from which three-dimensional information can be determined for a subject in the images. Storage 712 may also include an avatar store 738, which may store data used to generate graphical representations of user movement, such as geographic data, texture data, predefined characters, and the like.

In one or more embodiments, the classification module 724 may be configured to determine, for a given set of 3D sample points, a classification of the point with respect to a volume of the subject captured in the images. As described above, the classification module may use an input vector, which may be based in part on a feature vector extracted from an input image and generated from a feature encoder 728, and a depth coordinate of a 3D sample point to predict a relative position of the 3D sample point to a volume of a subject in the input image.

The joint network 730 is configured to predict joint locations for a user based on image data, for example captured during an enrollment session. The joint network may use image data of a user, along with front depth and back depth data corresponding to the image data, to predict joint locations for the user. In some embodiments, the joint locations are stored, for example in avatar store 738, for use by avatar module 732 for generating and/or providing avatar data representative of a user of client device 702 to other devices across network 708 via network interface 722, such as client device(s) 704. Further, in some embodiments, the joint locations may be stored by one or more network device(s) 706 for use by client device 702 or other devices communicably connected across the network 708 for generating an avatar representation of the user of client device 702.

In some embodiments, the client device 702 may include other components utilized for user enrollment, such as one or more cameras 718 and/or other sensors 720, such as one or more depth sensors. In one or more embodiments, each of the one or more cameras 718 may be a traditional RGB camera, a depth camera, or the like. The one or more cameras 718 may capture input images of a subject for determining 3D information from 2D images. Further, cameras 718 may include a stereo or other multicamera system.

Although client device 702 is depicted as comprising the numerous components described above, and one or more embodiments, the various components and functionality of the components may be distributed differently across one or more additional devices, for example across a network. For example, in some embodiments, any combination of storage 712 may be partially or fully deployed on additional devices, such as network device(s) 706, or the like.

Further, in one or more embodiments, client device 702 may be comprised of multiple devices in the form of an electronic system. For example, input images may be captured from cameras on accessory devices communicably connected to the client device 702 across network 708, or a local network As another example, some or all of the computational functions described as being performed by computer code in memory 710 may be offloaded to an accessory device communicably coupled to the client device 702, a network device such as a server, or the like. Accordingly, although certain calls and transmissions are described herein with respect to the particular systems as depicted, in one or more embodiments, the various calls and transmissions may be differently directed based on the differently distributed functionality. Further, additional components may be used, or some combination of the functionality of any of the components may be combined.

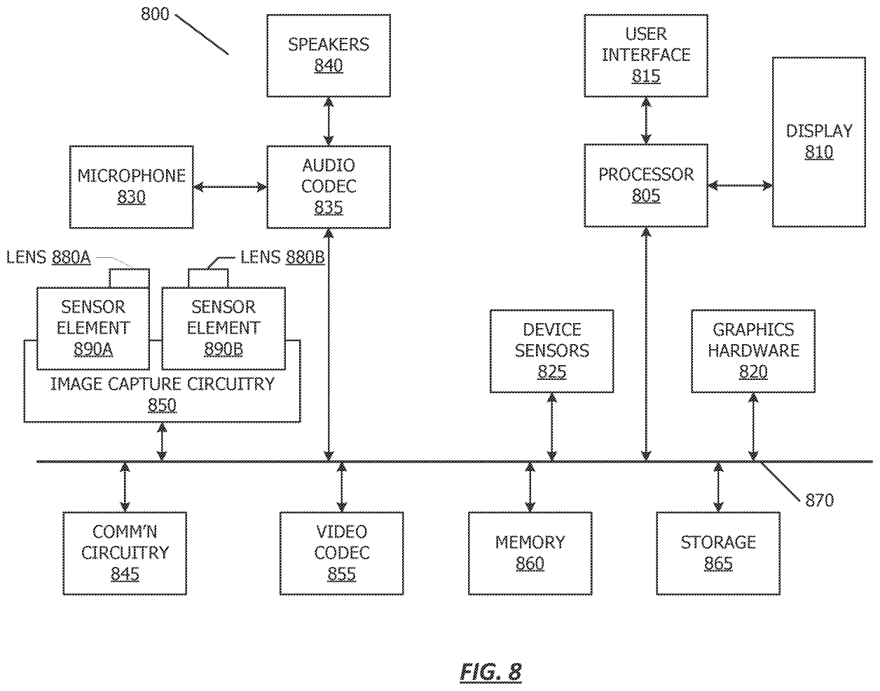

Referring now to FIG. 8, a simplified functional block diagram of illustrative multifunction electronic device 800 is shown according to one embodiment. Each of the electronic devices may be a multifunctional electronic device or may have some or all of the described components of a multifunctional electronic device described herein. Multifunction electronic device 800 may include some combination of processor 805, display 810, user interface 815, graphics hardware 820, device sensors 825 (e.g., proximity sensor/ambient light sensor, accelerometer and/or gyroscope), microphone 830, audio codec 835, speaker(s) 840, communications circuitry 845, digital image capture circuitry 850 (e.g., including camera system), memory 860, storage device 865, and communications bus 870. Multifunction electronic device 800 may be, for example, a mobile telephone, personal music player, wearable device, tablet computer, and the like.

Processor 805 may execute instructions necessary to carry out or control the operation of many functions performed by device 800. Processor 805 may, for instance, drive display 810 and receive user input from user interface 815. User interface 815 may allow a user to interact with device 800. For example, user interface 815 can take a variety of forms, such as a button, keypad, dial, a click wheel, keyboard, display screen, touch screen, and the like. Processor 805 may also, for example, be a system-on-chip such as those found in mobile devices and include a dedicated GPU. Processor 805 may be based on reduced instruction-set computer (RISC) or complex instruction-set computer (CISC) architectures or any other suitable architecture and may include one or more processing cores. Graphics hardware 820 may be special purpose computational hardware for processing graphics and/or assisting processor 805 to process graphics information. In one embodiment, graphics hardware 820 may include a programmable GPU.

Image capture circuitry 850 may include one or more lens assemblies, such as 880A and 880B. The lens assemblies may have a combination of various characteristics, such as differing focal length and the like. For example, lens assembly 880A may have a short focal length relative to the focal length of lens assembly 880B. Each lens assembly may have a separate associated sensor element 890. Alternatively, two or more lens assemblies may share a common sensor element. Image capture circuitry 850 may capture still images, video images, enhanced images, and the like. Output from image capture circuitry 850 may be processed, at least in part, by video codec(s) 855 and/or processor 805, and/or graphics hardware 820, and/or a dedicated image processing unit or pipeline incorporated within circuitry 845. Images so captured may be stored in memory 860 and/or storage 865.

Memory 860 may include one or more different types of media used by processor 805 and graphics hardware 820 to perform device functions. For example, memory 860 may include memory cache, read-only memory (ROM), and/or random access memory (RAM). Storage 865 may store media (e.g., audio, image and video files), computer program instructions or software, preference information, device profile information, and any other suitable data. Storage 865 may include one more non-transitory computer-readable storage mediums, including, for example, magnetic disks (fixed, floppy, and removable) and tape, optical media such as CD-ROMs and digital video discs (DVDs), and semiconductor memory devices such as Electrically Programmable Read-Only Memory (EPROM), and Electrically Erasable Programmable Read-Only Memory (EEPROM). Memory 860 and storage 865 may be used to tangibly retain computer program instructions or computer readable code organized into one or more modules and written in any desired computer programming language. When executed by, for example, processor 805, such computer program code may implement one or more of the methods described herein.

A physical environment refers to a physical world that people can sense and/or interact with without aid of electronic devices. The physical environment may include physical features such as a physical surface or a physical object. For example, the physical environment corresponds to a physical park that includes physical trees, physical buildings, and physical people. People can directly sense and/or interact with the physical environment such as through sight, touch, hearing, taste, and smell. In contrast, an XR environment refers to a wholly or partially simulated environment that people sense and/or interact with via an electronic device. For example, the XR environment may include augmented reality (AR) content, mixed reality (MR) content, virtual reality (VR) content, and/or the like. With an XR system, a subset of a person's physical motions, or representations thereof, are tracked, and in response, one or more characteristics of one or more virtual objects simulated in the XR environment are adjusted in a manner that comports with at least one law of physics. As one example, the XR system may detect head movement and, in response, adjust graphical content and an acoustic field presented to the person in a manner similar to how such views and sounds would change in a physical environment. As another example, the XR system may detect movement of the electronic device presenting the XR environment (e.g., a mobile phone, a tablet, a laptop, or the like) and, in response, adjust graphical content and an acoustic field presented to the person in a manner similar to how such views and sounds would change in a physical environment. In some situations (e.g., for accessibility reasons), the XR system may adjust characteristic(s) of graphical content in the XR environment in response to representations of physical motions (e.g., vocal commands).

It is to be understood that the above description is intended to be illustrative and not restrictive. The material has been presented to enable any person skilled in the art to make and use the disclosed subject matter as claimed and is provided in the context of particular embodiments, variations of which will be readily apparent to those skilled in the art (e.g., some of the disclosed embodiments may be used in combination with each other). Accordingly, the specific arrangement of steps or actions shown in FIGS. 1-4 and 6 or the arrangement of elements shown in FIGS. 5 and 7-8 should not be construed as limiting the scope of the disclosed subject matter. The scope of the invention therefore should be determined with reference to the appended claims, along with the full scope of equivalents to which such claims are entitled. In the appended claims, the terms “including” and “in which” are used as the plain English equivalents of the respective terms “comprising” and “wherein.”

1. A method comprising:
obtaining an image of a physical subject;
obtaining front depth data for a front portion of the physical subject;
generating back depth data for a back portion of the physical subject based on the image of the physical subject and the front depth data;
determining a set of joint locations for the physical subject from the image of the physical subject, the front depth data, and the back depth data.

2. The method of claim 1, wherein determining the set of joint locations comprises:
generating, by a trained network, a feature set corresponding to the physical subject based on the image of the physical subject, the front depth data, and the back depth data.

3. The method of claim 2, wherein the feature set corresponds to sample points for the subject, the method further comprising:
obtaining, for each of the sample points, a classifier value, wherein the classifier value indicates a relationship of the sample point to a volume corresponding to the physical subject.

4. The method of claim 3, wherein the back depth data is obtained based on the classifier value for the sample points.

5. The method of claim 1, wherein the back depth data is obtained from a second network configured to predict the back depth data based on the image of the physical subject and the front depth data.

6. The method of claim 1, wherein the front depth data is obtained by applying the image of the physical subject and depth sensor data to a second network configured to predict the front depth data, wherein the depth sensor data is captured in accordance with the image of the physical subject.

7. The method of claim 1, further comprising:
determining a skeleton for the physical subject based on the set of joint locations and inverse kinematics solver.

8. A non-transitory computer readable medium comprising computer readable code executable by one or more processors to:
obtain an image of a physical subject;
obtain front depth data for a front portion of the physical subject;
generate back depth data for a back portion of the physical subject based on the image of the physical subject and the front depth data; and
determine a set of joint locations for the physical subject from the image of the physical subject, the front depth data, and the back depth data.

9. The non-transitory computer readable medium of claim 8, wherein the computer readable code to determine the set of joint locations further comprises computer readable code to:
generate, by a trained network, a feature set corresponding to the physical subject based on the image of the physical subject, the front depth data, and the back depth data.

10. The non-transitory computer readable medium of claim 9, wherein the feature set corresponds to sample points for the subject, and further comprising computer readable code to:
obtain, for each of the sample points, a classifier value, wherein the classifier value indicates a relationship of the sample point to a volume corresponding to the physical subject.

11. The non-transitory computer readable medium of claim 10, wherein the back depth data is obtained based on the classifier value for the sample points.

12. The non-transitory computer readable medium of claim 8, wherein the back depth data is obtained from a second network configured to predict the back depth data based on the image of the physical subject and the front depth data.

13. The non-transitory computer readable medium of claim 8, wherein the front depth data is obtained by applying the image of the physical subject and depth sensor data to a second network configured to predict the front depth data, wherein the depth sensor data is captured in accordance with the image of the physical subject.

14. The non-transitory computer readable medium of claim 8, further comprising computer readable code to:
determine a skeleton for the physical subject based on the set of joint locations and inverse kinematics solver.

15. A system comprising:
one or more processors; and
one or more computer readable media comprising computer readable code executable by the one or more processors to:
obtain an image of a physical subject;
obtain front depth data for a front portion of the physical subject;
generate back depth data for a back portion of the physical subject based on the image of the physical subject and the front depth data; and
determine a set of joint locations for the physical subject from the image of the physical subject, the front depth data, and the back depth data.

16. The system of claim 15, wherein the computer readable code to determine the set of joint locations further comprises computer readable code to:
generate, by a trained network, a feature set corresponding to the physical subject based on the image of the physical subject, the front depth data, and the back depth data.

17. The system of claim 16, wherein the feature set corresponds to sample points for the subject, and further comprising computer readable code to:
obtain, for each of the sample points, a classifier value, wherein the classifier value indicates a relationship of the sample point to a volume corresponding to the physical subject.

18. The system of claim 17, wherein the back depth data is obtained based on the classifier value for the sample points.

19. The system of claim 15, wherein the back depth data is obtained from a second network configured to predict the back depth data based on the image of the physical subject and the front depth data.

20. The system of claim 15, wherein the front depth data is obtained by applying the image of the physical subject and depth sensor data to a second network configured to predict the front depth data, wherein the depth sensor data is captured in accordance with the image of the physical subject.
